(19) United States
(12) Patent Application Publication
(10) Pub. No.: US 2008/0129999 A1
(43) Pub. Date: Jun. 5, 2008

(54) Method and a device for measuring axial polarizing angle of polarizer

(75) Inventors: Jia Chiang Lin, Pingzhen City (TW); Ching Sen Chang, Pingzhen City (TW); Ching Huang Lin, Pingzhen City (TW); Long Hai Wu, Pingzhen City (TW)

Correspondence Address: TROXELL LAW OFFICE PLLC, SUITE 1404, 5205 LEESBURG PIKE, FALLS CHURCH, VA, 22041, US

(73) Assignee: OPTIMAX Technology Corporation

(21) Appl. No.: 11/790,468

(22) Filed: Apr. 25, 2007

(30) Foreign Application Priority Data
Dec. 1, 2006 (TW) 095144587

(51) Int. Cl. G01J 4/00

(52) U.S. Cl. 356/367

(57) ABSTRACT

The present invention relates to a device and a method for measuring an axial polarizing angle of a polarizer. The apparatus can have a to-be-measured polarizer disposed therein, and comprises a light generating device, a light polarizing device and a measurement comparison device. The light generating device provides a light source. The light polarizing device is disposed corresponding to the light generating device to load the to-be-measured polarizer, and measures a light signal after the light source passes through the to-be-measured polarizer without rotating the to-be-measured polarizer, and transforms it into readable data. The measurement comparison device is electrically connected with the light polarizing device and has at least one preset comparison data to receive the data provided by the light polarizing device and compare it with the comparison data. Thus, after comparing the data provided by the light polarizing device with the comparison data, an axial polarizing angle of the to-be-measured polarizer is quickly and accurately measured and calculated.

### BACKGROUND OF INVENTION

1. Field of the Invention

The present invention relates to an apparatus and a method for measuring an axial polarizing angle of a polarizer, and more particularly, to an apparatus and a method that quickly measures an axial polarizing angle of the polarizer without rotating the polarizer, so as to achieve real-time audit of a manufacturing process of the polarizer.

2. Description of the Prior Art

LCD has been widely used in various electronic information devices, such as televisions, computers, cell phones and PDA. For LCD panels on the market, liquid crystal molecules are between solid phase and liquid phase, and such molecules not only flows easily as liquid does in response to external forces, but also have the property of optical anisotropy as a crystal does. Therefore, an external electric field can drive the arrangement of liquid crystal to other directions, resulting in the change of the optical characteristics of lights passing through the liquid crystal layer. Such modulation of light by an external electric field is called the photoelectric effect of liquid crystal. By taking advantage of this effect, various liquid crystal display panel can be produced, such as the TN-Twisted nematic liquid crystal display panel, the STN-Super TN liquid crystal display panel, TFT-Thin Film Transistor liquid crystal display panel and so on.

As shown in FIG. 1A, which is the schematic drawing that shows a conventional TN-twisted nematic liquid crystal display panel without an electric charge, a TN-twisted nematic liquid crystal display device 100 includes alignment layers 110 and 120 with fine grooves 105 and 106 formed by rubbing, and polarizers 130 and 140 for polarizing the directions of scattered lights. When nematic liquid crystal 150 is poured in between the alignment layers 110 and 120, the nematic liquid crystal 150 arranges along the grooves 105 and 106 easily because of the flowing characteristic of the molecule thereof. The constraint force acting upon the nematic liquid crystal 150 is greater near the grooves 105 and 106, and thus the nematic liquid crystal 150 arranges along the grooves 105 and 106. The constraint force acting upon the nematic liquid crystal 150 is weaker in the middle section and therefore arranges in a twisted manner. The nematic liquid crystal 150 inside the alignment layers 110 and 120 is twisted for 90 degree in total, thus is called the TN-twisted nematic type. Therefore, when there is no electric field between the alignment layers 110 and 120, the direction of light 160 rotates 90 degrees along with the direction of the liquid crystal after entering the polarizer 140 and the alignment layer 120, and then the direction of light 160 becomes the same as the polarizing direction of the alignment layer 110 and the polarizer 130, thus light can pass through the polarizer 130 successfully.

Please refer to FIG. 1B, which is the schematic drawing of a conventional TN-twisted nematic liquid crystal display panel with an electric charge. When a voltage is applied on the alignment layers 110 and 120, the nematic liquid crystal 150 tends to become parallel to the direction of the electric field (as shown in the figure). Thus, the nematic liquid crystal 150 becomes perpendicular to the surface of the alignment layer 110 and then to 120. The direction of light 160 does not change after entering the polarizer 140 and the alignment layer 120, thus the light can not pass through the polarizer 130 when arriving at the polarizer 130.

From what is mentioned above, it is known that the angle included between the two polarizers 130 and 140 is 90 degree. The included angle between the two polarizers 130 and 140 affects the quality of a liquid crystal display panel greatly, thus the accuracy of an axial polarizing angle of the polarizer is especially important.

Please refer to FIG. 2, which is the lateral structural schematic drawing of a conventional apparatus for measuring an axial polarizing angle of the polarizer. The conventional apparatus 2 for measuring an axial polarizing angle of the polarizer includes a light generator 21, a light-filter 211, one or a plurality of retardation plates 22, a polarizer 23 with a known axial polarizing angle, and a receiving calculator 24. The light generated from the light generator 21 becomes a monochromatic light source 26 having a narrow wave-length range after passing through the light-filter 211. A to-be-measured polarizer 25 is disposed between the light-filter 211 and the retardation plates 22, and then the monochromatic light source 26 passes through the to-be-measured polarizer 25 and forms a linearly polarized light 261. The linearly polarized light 261 generates elliptic polarized light 262 with preset polarization state after passing through the retardation plates 22. In the prior art, the monochromatic light source 26 is used and the luminous intensity of the elliptic polarized light 262 generated thereby is a constant. Therefore, by rotating the polarizer 23 with a known axial polarizing angle, the transmission rate thereof can be changed to be different. Thus, in the prior art, when measuring the axial polarizing angle of the to-be-measured polarizer 25, one of the retardation plates 22, the to-be-measured polarizer 25 and the polarizer 23 with a known axial polarizing angle must rotate, and then the receiving calculator 24 measures the transmittance of light of a narrow wave band ( also known as the monochromatic light). After rotating 180 degrees or even 360 degrees, the relation of measured light transmission rate and the rotating angle is analyzed to get the angle of polarized light of the to-be-measured polarizer 25.

The above-mentioned conventional apparatus 2 for measuring an axial polarizing angle of the polarizer needs to rotate some of its components and it takes a long time to perform the measurement (usually one or several seconds), thus is not suitable for the real-time audit. Therefore, solution to the abovementioned problem is the most urgent issue for the industry right now.

### SUMMARY OF INVENTION

One objective of the present invention is to provide an apparatus and a method for measuring an axial polarizing angle of a polarizer without rotating the optical components, and the signals are quickly collected to achieve the effect of reducing the time required for measuring.

Another objective of the present invention is to provide an apparatus and a method for measuring an axial polarizing angle of a polarizer, which is adaptable for measuring a large number of polarizers of various specifications for lowering the measurement cost and reducing the occurrence of erroneousness.

Still another objective of the present invention is to provide an apparatus and a method for measuring an axial polarizing angle of a polarizer to lower the time required for measuring to less than 0.1 second, and to be used in the real-time audit production process.

In order to achieve aforementioned objectives, an embodiment of the apparatus for measuring an axial polarizing angle of a polarizer in accordance with the present invention is disclosed. The apparatus can have a to-be-measured polarizer disposed therein, and comprises a light generating device, a light polarizing device and a measurement comparison device. The light generating device provides a light source. The light polarizing device is disposed corresponding to the light generating device to load the to-be-measured polarizer, and measures a light signal after the light source passes through the to-be-measured polarizer without rotating the to-be-measured polarizer, and transforms it into readable data. The measurement comparison device is electrically connected with the light polarizing device and has at least one preset comparison data to receive the data provided by the light polarizing device and compare it with the comparison data. Thus, after comparing the data provided by the light polarizing device with the comparison data, an axial polarizing angle of the to-be-measured polarizer is quickly and accurately measured and calculated.

Preferably, the light polarizing device further comprises:

a light collecting module for receiving the light source;

at least one retardation plate and a preset polarizer disposed between the light generating device and the light collecting module for the light source to pass through; and

a light signal transforming member connected to the light collecting module for transforming the light signal of the light source into readable data.

In order to achieve aforementioned objectives, the present invention further discloses a method for measuring an axial polarizing angle of a polarizer, which comprises the steps of:

(a) providing an apparatus for measuring an axial polarizing angle of the polarizer, including a light generating device, a light polarizing device and a measurement comparison device, the light generating device being adapted to provide a light source, the light polarizing device being disposed corresponding to the light generating device, the measurement comparison device being electrically connected to the light polarizing device;

(b) disposing a sample polarizer between the light generating device and the light polarizing device, so as to allow the light source to pass through the sample polarizer and arriving at the light polarizing device, and a first curve is measured and recorded in the measurement comparison device;

(c) taking out the sample polarizer;

(d) disposing a to-be-measured polarizer between the light generating device and the light polarizing device, so as to allow the light source to pass through the to-be-measured polarizer and arriving at the light polarizing device, and a second curve is measured and recorded in the measurement comparison device; and

(e) comparing the first curve and the second curve by the measurement comparison device, calculating an axial polarizing angle of the to-be-measured polarizer.

In a second embodiment of the present invention, the method for measuring an axial polarizing angle of a polarizer comprises the steps of:

(a) providing an apparatus for measuring an axial polarizing angle of the polarizer, including a light generating device, a light polarizing device and a measurement comparison device, the light generating device provides a light source, the light polarizing device being disposed corresponding to the light generating device, the measurement comparison device being electrically connected to the light polarizing device and a plurality of comparison data being preset inside;

(b) disposing a to-be-measured polarizer between the light generating device and the light polarizing device;

(c) the light source passing the to-be-measured polarizer and arriving at the light polarizing device, and a measured data being received and recorded in the measurement comparison device; and

(d) comparing the measured data and the comparison data by the measurement comparison device, making one of the comparison data most similar to the measured data.

### BRIEF DESCRIPTION OF THE DRAWINGS

The details of the present invention will be more readily understood from a detailed description of the preferred embodiments taken in conjunction with the following figures.

FIG. 1A is the schematic drawing showing the operation of a conventional TN-twisted nematic liquid crystal display panel without an electric charge.

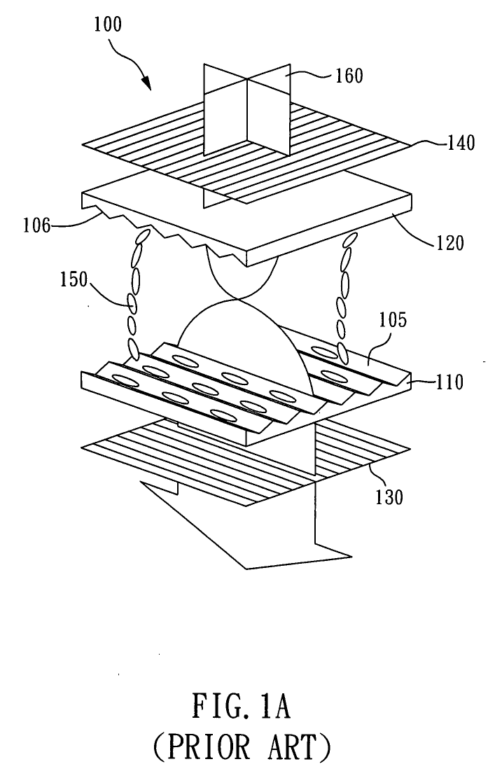

FIG. 1B is the schematic drawing of a conventional TN-twisted nematic liquid crystal display panel with an electric charge.

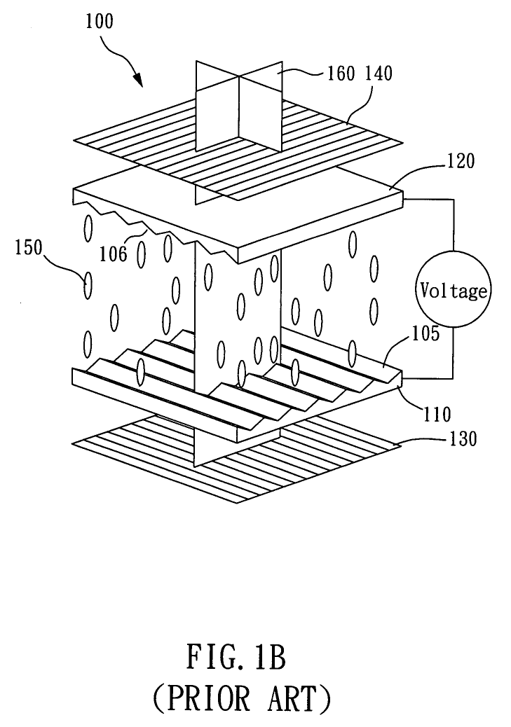

FIG. 2 is the lateral structural schematic drawing of a conventional apparatus for measuring an axial polarizing angle of the polarizer.

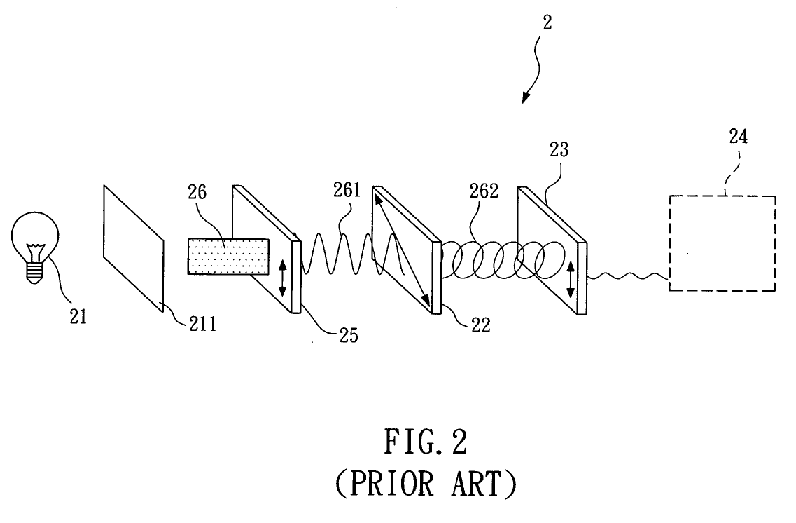

FIG. 3A is a schematic drawing showing the apparatus for measuring an axial polarizing angle of the polarizer in a preferred embodiment of the present invention.

FIG. 3B is a schematic drawing showing the wavelength/polarized-state comparison of the linearly polarized light and the elliptic polarized light formed by the apparatus for measuring an axial polarizing angle of the polarizer in a preferred embodiment of the present invention.

FIG. 3C is a schematic drawing showing the wavelength/transmission curve function comparison of the apparatus for measuring an axial polarizing angle of the polarizer in a preferred embodiment of the present invention.

FIG. 4 is a flow chart showing the method for measuring an axial polarizing angle of the polarizer in the first preferred embodiment of the present invention.

FIG. 5 is a flow chart showing the method for measuring an axial polarizing angle of the polarizer in the second preferred embodiment of the present invention.

### DETAILED DESCRIPTION

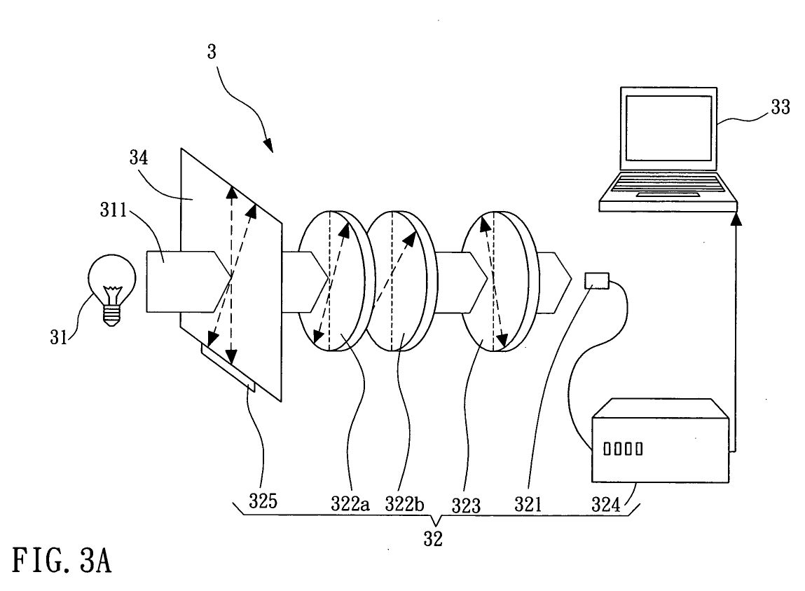

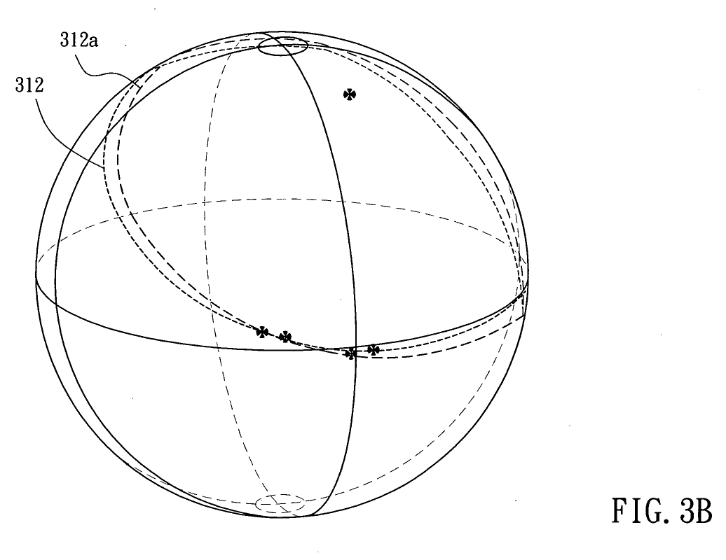

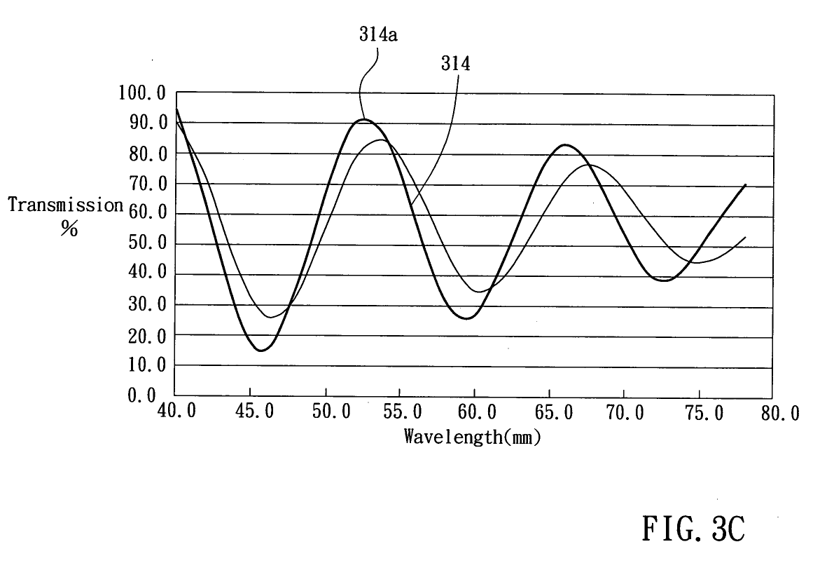

Please refer to FIG. 3A, which is a schematic drawing showing the apparatus for measuring an axial polarizing angle of the polarizer in a preferred embodiment of the present invention. The apparatus 3 for measuring an axial polarizing angle of the polarizer includes a light generating device 31, a light polarizing device 32 and a measurement comparison device 33. The light generating device 31 provides a light source 311, and the light source 311 may be provided at several different wavelengths (i.e. polychrome light or white light). The light polarizing device 32 is disposed corresponding to the light generating device 31 for receiving the light signal of the light source 311 and transforming it into readable data. In the preferred embodiment of the present invention, the light polarizing device 32 further includes a light collecting module 321, at least one retardation plate 322a, 322b, a preset polarizer 323 (the axial polarizing angle is known) and a light signal transforming member 324. The light collecting module 321 receives the light source 311 passing through the retardation plates 322a and 322b and the preset polarizer 323, and usually includes a lens set, optical fibers and so on. The retardation plates 322a and 322b and the preset polarizer 323 are disposed between the light generating device 31 and the light collecting module 321 for changing lights of different wavelengths to different polarization states after the light source 311 passes through. Wherein, it is preferred to have a small difference of angle between the deflection angles of the retardation plates 322a and 322b. The light signal transforming member 324 is connected to the light collecting module 321 for transforming the light signals it receives into readable data. The light signal transforming member 324 is preferred to include an image collecting device comprising a CCD or a CMOS and a spectrometer.

The measurement comparison device 33 is electrically connected with the light polarizing device 32 and has at least one preset comparison data inside. The measurement comparison device 33 can receive the data provided by the light polarizing device 32 and compare it with the preset comparison data. In the preferred embodiment of the present invention, the measurement comparison device 33 can be a computer.

In the preferred embodiment of the present invention, the light polarizing device 32 further includes a loading seat 325 disposed between the light generating device 31 and the retardation plate 322. The loading seat 325 is not for rotating but for an operator or an automatic mechanism equipment to quickly locate it when disposing or removing a to-be-measured polarizer 34 on the light polarizing device 32. Please refer to FIG. 3B and FIG. 3C, which are schematic drawings showing the wavelength/polarized-state comparison of the linearly polarized light and the elliptic polarized light formed by the apparatus for measuring an axial polarizing angle of the polarizer when the angle of the to-be-measured sample changes, and the wavelength/transmission curve function comparison. First, a sample polarizer (the axial polarizing angle is zero degree or known) is disposed on the loading seat 325, and the light source 311 passes the sample polarizer to become a linearly polarized light. After the linearly polarized light passes through the retardation plate 322 again, because the retardation plate 322 generates varied phase difference according to different wave bands, different polarization states 312 are generated due to different wavelengths. At last, a curve function drawing 314 of the sample polarizer is presented by passing through the preset polarizer 323. The curve function drawing 314 is shown on a spectrometer and recorded as a comparison data by the measurement comparison device 33.

Thus, when measuring the to-be-measured polarizer 34, firstly disposing the to-be-measured polarizer 34 onto the loading seat 325; after the light source 311 passes through the to-be-measured polarizer 34 and the retardation plate 322, lights of various wavelengths form an elliptic polarized light 312a. Please refer to FIG. 3B and FIG. 3C again. The elliptic polarized light 312a passes the preset polarizer 323 again, and a transmission curve function drawing 314a of the to-be-measured polarizer 34 is presented. At last, the measurement comparison device 33 compares the wavelength peak and/or amplitude variation of the spectrum with the comparison data, so as to calculate the axial polarizing angle of the to-be-measured polarizer 34.

Certainly, in another preferred embodiment of the present invention, each sample polarizer of different axial polarizing angles can be disposed in sequence, and then the measurement comparison device 33 records these comparison data. Thus, after a to-be-measured polarizer 34 is disposed to get the transmission curve function drawing 314, these data can be searched to find the most similar drawing as the axial polarizing angle of the to-be-measured polarizer 34.

The apparatus 3 for measuring an axial polarizing angle of the polarizer according to the present invention does not need to rotate any component and can get the axial polarizing angle directly by data comparison and calculation, thus the time required for measurement is lowered to less than 0.1 second, which benefits the real-time audit of the production process of the polarizer or the measurement of a large number of polarizers.

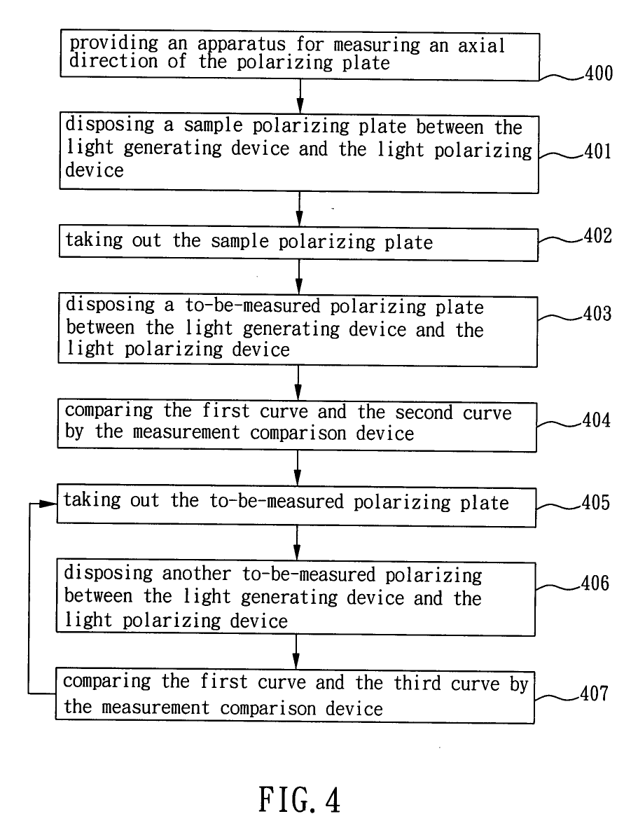

Please refer to FIG. 4, which is a flow chart showing the method for measuring an axial polarizing angle of the polarizer in the first preferred embodiment of the present invention, comprising the following steps:

step (a): providing an apparatus for measuring an axial polarizing angle of the polarizer (Step 400), including: a light generating device, a light polarizing device and a measurement comparison device. The light generating device provides a light source, and the light polarizing device is disposed corresponding to the light generating device. The measurement comparison device is electrically connected with the light polarizing device.

step (b): disposing a sample polarizer between the light generating device and the light polarizing device (Step 401). The light source passes the sample polarizer and arrives at the light polarizing device, and a first curve is measured and recorded in the measurement comparison device. The light polarizing device measures the first curve by a spectrometer, and thus the first curve is a transmission rate function curve. The x-coordinate is the wavelength and the y-coordinate is the function curve corresponding to the transmission rate.

step (c): taking out the sample polarizer (Step 402).

step (d): disposing a to-be-measured polarizer between the light generating device and the light polarizing device (Step 403). The light source passes the to-be-measured polarizer and arrives at the light polarizing device, and a second curve is measured and recorded in the measurement comparison device. The second curve is also a transmission rate function curve.

step (e): comparing the first curve and the second curve by the measurement comparison device (Step 404), and calculating an axial polarizing angle of the to-be-measured polarizer. The measurement comparison device is a computer and calculates the wavelength peak difference of the first curve and the second curve, and/or the amplitude variation of the spectrum, so as to get the axial polarizing angle of the to-be-measured polarizer.

Because the present invention can be used in a real-time audit of the production process of polarizers, another to-be-measured polarizer will be disposed anytime. After the preferred step (e), further steps are comprised as follows:

step (f): taking out the to-be-measured polarizer (Step 405).

step (g): disposing another to-be-measured polarizer between the light generating device and the light polarizing device (Step 406). The light source passes the to-be-measured polarizer and arrives at the light polarizing device, and a third curve is measured and recorded in the measurement comparison device.

step (h): comparing the first curve and the third curve by the measurement comparison device (Step 407), and calculating an axial polarizing angle of the to-be-measured polarizer.

step (i): repeating from step (f) to step (h). Therefore, quick measuring of an axial polarizing angle of a plurality of to-be-measured polarizer can be achieved.

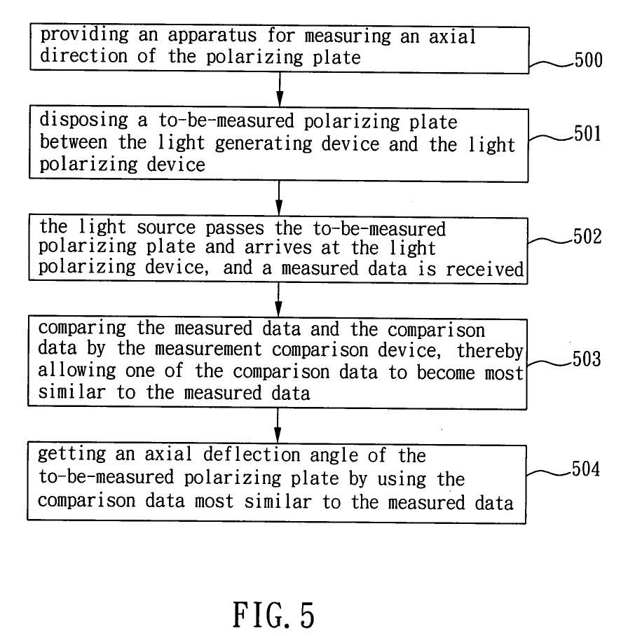

Please refer to FIG. 5, which is a flow chart showing the method for measuring an axial polarizing angle of the polarizer in the second preferred embodiment of the present invention, comprising the following steps:

step (a): providing an apparatus for measuring an axial polarizing angle of the polarizer (Step 500), including: a light generating device, a light polarizing device and a measurement comparison device. The light generating device provides a light source, and the light polarizing device is disposed corresponding to the light generating device. The measurement comparison device is electrically connected with the light polarizing device, and a plurality of comparison data is preset inside. At least one sample polarizer with known axial polarizing angle is disposed between the light generating device and the light polarizing device. The light source passes the sample polarizer and arrives at the light polarizing device and gets a comparison data and records it in the measurement comparison device. The light polarizing device measures the comparison data by a spectrometer, and thus the comparison data is a transmission rate function curve. The x-coordinate is the wavelength and the y-coordinate is the function curve corresponding to the transmission rate.

step (b): disposing a to-be-measured polarizer between the light generating device and the light polarizing device (Step 501).

step (c): the light source passes the to-be-measured polarizer and arrives at the light polarizing device, and a measured data is received (Step 502), and recorded in the measurement comparison device. The measured data is also a transmission rate function curve. The x-coordinate is the wavelength and the y-coordinate is the function curve corresponding to the transmission rate.

step (d): comparing the measured data and the comparison data by the measurement comparison device, thereby allowing one of the comparison data to become most similar to the measured data (Step 503).

step (e): getting an axial polarizing angle of the to-be-measured polarizer by using the comparison data most similar to the measured data (Step 504). Certainly, the measurement comparison device can compare the wavelength peak difference and/or amplitude variation of the spectrum of the measured data and the comparison data most similar to the measured data, so as to calculate the axial polarizing angle of the to-be-measured polarizer.

While the invention has been described by way of examples and in terms of the preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. Accordingly, that above disclosure should be construed as limited only by the metes and bounds of the appended claims.

What is claimed is:

1. An apparatus for measuring an axial polarizing angle of a polarizer for a to-be-measured polarizer to be disposed therein, the apparatus comprising:
a light generating device for providing a light source;
a light polarizing device disposed corresponding to the light generating device, the light polarizing device being adapted to load the to-be-measured polarizer and receive a light signal of the light source to transform the light signal into readable data; and
a measurement comparison device electrically connected to the light polarizing device and having at least one preset comparison data, the measurement comparison device being adapted to receive the data from the light polarizing device, and compare the data with the comparison data, so as to get an axial polarizing angle of the to-be-measured polarizer.

2. The apparatus for measuring an axial polarizing angle of a polarizer as claimed in claim 1, wherein the light polarizing device further comprises:
a light collecting module for receiving the light source;
at least one retardation plate and a preset polarizer disposed between the light generating device and the light collecting module for the light source to pass through; and
a light signal transforming member connected to the light collecting module for transforming the light signal of the light source into readable data.

3. The measuring apparatus for measuring an axial polarizing angle of a polarizer as claimed in claim 2, wherein the light polarizing device further comprises a loading seat disposed between the light generating device and the retardation plate, and is adapted to load the to-be-measured polarizer, so as to allow the light source to pass through the to-be-measured polarizer and be received by the light collecting module.

4. The apparatus for measuring an axial polarizing angle of a polarizer as claimed in claim 1, wherein the light source can be of several different wavelengths.

5. The apparatus for measuring an axial polarizing angle of a polarizer as claimed in claim 2, wherein the light signal transforming member is adapted to be a spectrometer.

6. The apparatus for measuring an axial polarizing angle of a polarizer as claimed in claim 1, wherein the measurement comparison device is adapted to be a computer.

7. The method for measuring an axial polarizing angle of a polarizer, comprising the steps of:
(a) providing an apparatus for measuring an axial polarizing angle of the polarizer, including a light generating device, a light polarizing device and a measurement comparison device, the light generating device being adapted to provide a light source, the light polarizing device being disposed corresponding to the light generating device, the measurement comparison device being electrically connected to the light polarizing device;
(b) disposing a sample polarizer between the light generating device and the light polarizing device, so as to allow the light source to pass through the sample polarizer and arriving at the light polarizing device, and a first curve is measured and recorded in the measurement comparison device;
(c) taking out the sample polarizer;
(d) disposing a to-be-measured polarizer between the light generating device and the light polarizing device, so as to allow the light source to pass through the to-be-measured polarizer and arriving at the light polarizing device, and a second curve is measured and recorded in the measurement comparison device; and
(e) comparing the first curve and the second curve by the measurement comparison device, calculating an axial polarizing angle of the to-be-measured polarizer.

8. The method for measuring an axial polarizing angle of a polarizer as claimed in claim 7, wherein the first curve and the second curve in the step (b) and the step (d) are transmission rate function curves.

9. The method for measuring an axial polarizing angle of a polarizer as claimed in claim 7, wherein the first curve and the second curve in the step (b) and the step (d) have a x-coordinate to represent the wavelength, and a y-coordinate to represent the function curve corresponding to the transmission rate.

10. The method for measuring an axial polarizing angle of a polarizer as claimed in claim 7, wherein a wavelength peak difference between the first curve and the second curve is calculated to get the axial polarizing angle of the to-be-measured polarizer in the step (e).

11. The method for measuring an axial polarizing angle of a polarizer as claimed in claim 7, wherein an amplitude variation between the spectrum of the first curve and the second curve is calculated to get the axial polarizing angle of the to-be-measured polarizer in the step (e).

12. The method for measuring an axial polarizing angle of a polarizer as claimed in claim 7, wherein following steps are after the step (e):
(f) taking out the to-be-measured polarizer;
(g) disposing another to-be-measured polarizer between the light generating device and the light polarizing device, the light source passes through the to-be-measured polarizer and arrives at the light polarizing device, so that a third curve is measured and recorded in the measurement comparison device; and
(h) comparing the first curve and the third curve by the measurement comparison device, and calculating an axial polarizing angle of the to-be-measured polarizer.

13. The method for measuring an axial polarizing angle of a polarizer as claimed in claim 12, wherein a following step is after the step (h):
(i) repeating from the step (f) to the step (h) to measure an axial polarizing angle of a plurality of to-be-measured polarizer.

14. The method for measuring an axial polarizing angle of a polarizer, comprising the steps of:
(a) providing an apparatus for measuring an axial polarizing angle of the polarizer, including a light generating device, a light polarizing device and a measurement comparison device, the light generating device provides a light source, the light polarizing device being disposed corresponding to the light generating device, the measurement comparison device being electrically connected to the light polarizing device and a plurality of comparison data being preset inside;
(b) disposing a to-be-measured polarizer between the light generating device and the light polarizing device;
(c) the light source passing the to-be-measured polarizer and arriving at the light polarizing device, and a measured data being received and recorded in the measurement comparison device; and
(d) comparing the measured data and the comparison data by the measurement comparison device, making one of the comparison data most similar to the measured data.

15. The method for measuring an axial polarizing angle of a polarizer as claimed in claim 14, wherein the comparison data in the step (a) is obtained from disposing at least one sample polarizer between the light generating device and the light polarizing device, the light source is allowed to pass through the sample polarizer and arrive at the light polarizing device to get a comparison data to be recorded in the measurement comparison device.

16. The method for measuring an axial polarizing angle of a polarizer as claimed in claim 14, wherein the comparison data and the measured data in the step (a) and the step (c) are transmission rate function curves.

17. The method for measuring an axial polarizing angle of a polarizer as claimed in claim 14, wherein the comparison data and the measured data in the step (a) and the step (c) have a x-coordinate to represent the wavelength and a y-coordinate to represent the function curve corresponding to the transmission rate.

18. The method for measuring an axial polarizing angle of a polarizer as claimed in claim 14, wherein a following step is after the step (d):
(e) getting an axial polarizing angle of the to-be-measured polarizer from the comparison data most similar to the measured data.

19. The method for measuring an axial polarizing angle of a polarizer as claimed in claim 14, wherein a following step is after the step (d):
(f) getting an axial polarizing angle of the to-be-measured polarizer by comparing the measured data and the comparison data most similar to the measured data in the measurement comparison device.

20. The method for measuring an axial polarizing angle of a polarizer as claimed in claim 19, wherein either or both of the wavelength peak difference and the amplitude variation between the spectrum of the measured data and the comparison data is used to calculate the axial polarizing angle of the to-be-measured polarizer in the step (f).
